(19) United States
(12) Patent Application Publication
(10) Pub. No.: US 2009/0271692 A1
(43) Pub. Date: Oct. 29, 2009

(54) METHOD FOR MAKING DIGITAL PHOTO ALBUM

(75) Inventors: Hong-Liang LIU, Shenzhen City (CN); Li-Juan LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/210,524

(22) Filed: Sep. 15, 2008

(30) Foreign Application Priority Data
Apr. 28, 2008 (CN) 200810301386.4

(51) Int. Cl. G06F 17/21

(52) U.S. Cl. 715/202

(57) ABSTRACT

A method for making a digital photo album on a digital photo frame, the method includes the following steps: selecting a plurality of photos in the digital photo album, and ranking the selected photos, reviewing each of the selected photos one at a time in the digital photo frame, detecting if there is audio input when reviewing each of the selected photos, recording the audio if audio input has been detected, and storing a plurality of information corresponding to the photo.

### BACKGROUND

1. Technical Field

The invention relates in general to a method for making a digital photo album.

2. Description of Related Art

Digital products are becoming increasingly popular. Many conventional devices have been replaced with their digital counterpart, such as digital cameras. As a result, the conventional method of developing photos and displaying them on conventional photo frames has become outdated, time-consuming, and expensive.

A digital photo frame has been developed to overcome the above-described shortcomings. The digital photo frame includes components such as a liquid crystal display (LCD) panel, where digital photos are displayed, and a memory, where digital photos are stored. The digital photos may be displayed in a particular order based on user preference or the order stored in the memory. In addition, digital photos can be selected one-by-one to be made into a digital photo album including music and customized subtitles corresponding to the digital photos. However, creating a digital photo album often requires professional knowledge and skill, which is significantly more difficult for non-professionals.

Therefore, a new digital photo frame is needed to overcome the above-described deficiency.

### BRIEF DESCRIPTION OF THE DRAWINGS

FIG. 1 is a schematic view of a digital photo frame.

FIG. 2 is a block diagram of the digital photo frame of FIG. 1.

FIG. 3 is a flowchart of an embodiment of a method for making digital photo albums, the method including steps 201 through 207.

FIG. 4 is a detailed flowchart of step 203 of the method of FIG. 3.

### DETAILED DESCRIPTION OF THE EMBODIMENTS

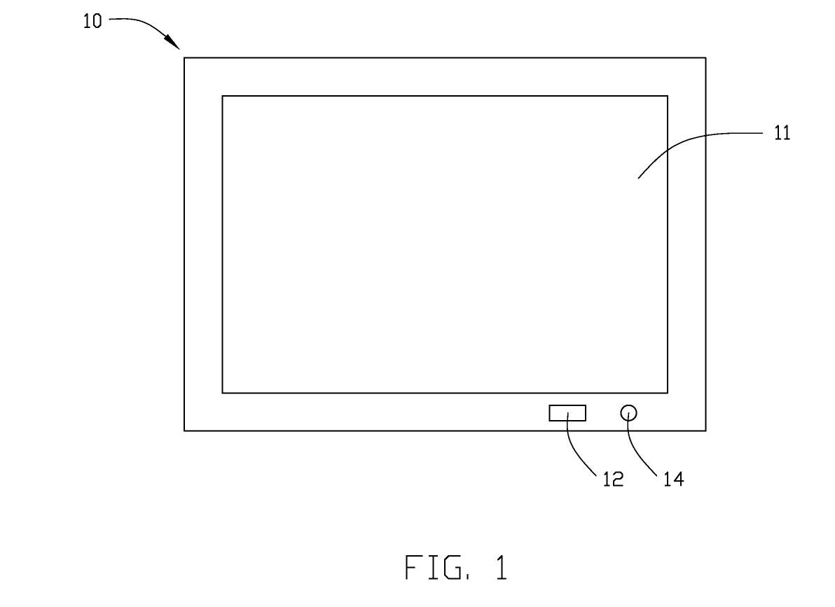

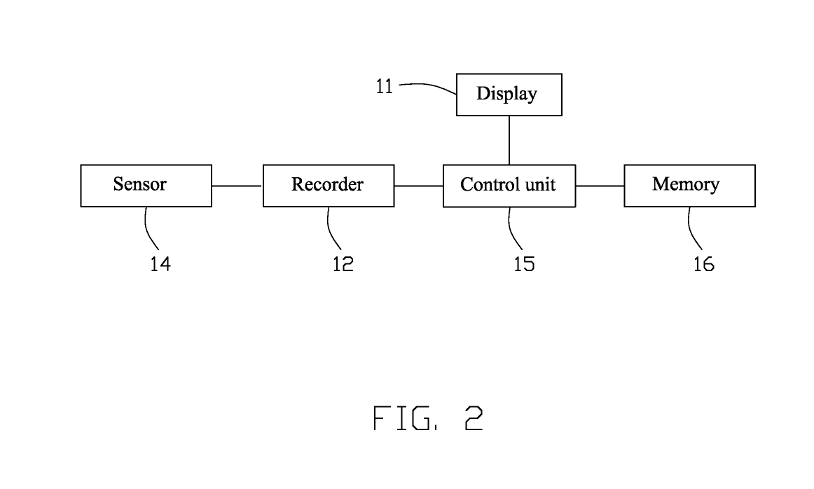

Referring to FIGS. 1 and 2, a digital photo frame 10 for making a digital photo album includes a display 11, a recorder 12, a sensor 14, a control unit 15, and memory 16. The control unit 15 is connected to the display 11, the recorder 12, and the memory 16. The recorder 12 records sound. The sensor 14 is connected to the recorder 12 for controlling the recorder 12. A plurality of digital photos is stored in the memory 16.

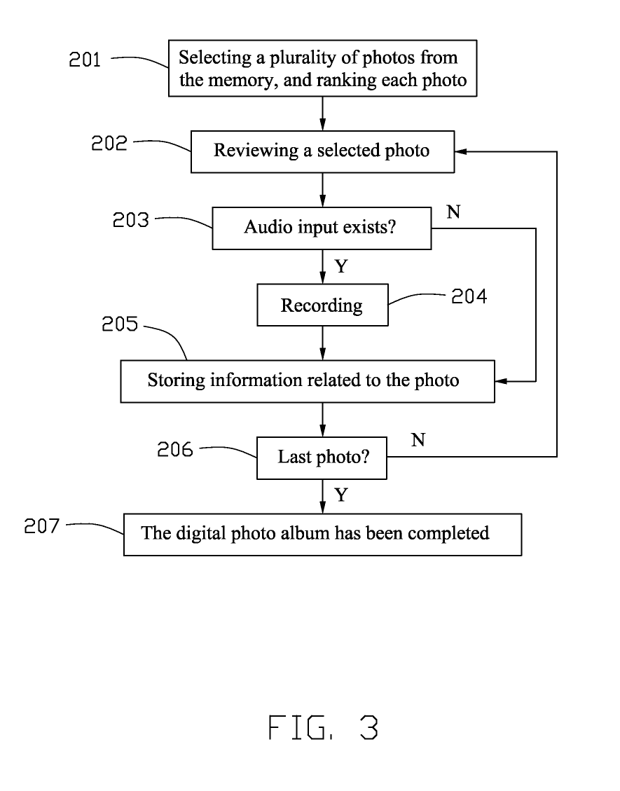

FIG. 3 illustrates a method for making a digital photo album. Depending on the embodiment, certain steps described below may be removed, while others may be added, and the sequence of steps may be altered as well.

In a step 201, the process of creating a digital photo album begins by selecting a plurality of photos from the memory, and ranking each photo by preference.

Moving to a step 202, one of the selected photos is reviewed.

Continuing to a decision step 203, the sensor 14 detects if there is audio input while reviewing the photo. The audio input, for example, may be an oral recording or background music corresponding to the photo. If audio input has been detected, then the method continues to a step 204, otherwise the method skips to a step 205.

In the step 204, if there is audio input, the recorder 12 records the audio and stores the audio in the memory 16 as an audio file. The method continues to the step 206.

In the step 205, the control unit 15 monitors the photo when the photo is reviewed, and then stores a plurality of information related to the photo in the memory 16. The plurality of information may include a location path of the photo, a duration time of reviewing the photo, and the corresponding audio file.

Continuing to a decision step 206, the control unit 15 checks if the selected photo is the last of the selected photos. If so, the process continues to a step 207, otherwise, the process returns to the step 202 to review the next selected photo.

In the step 207, the digital photo album has been completed.

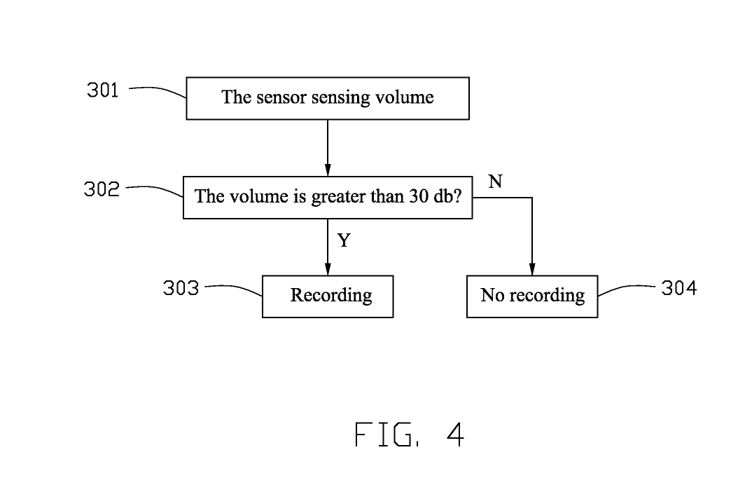

FIG. 4 illustrates step 203 of the method of FIG. 3 in detail. Depending on the embodiment, certain steps described below may be removed, while others may be added, and the sequence of steps may be altered as well.

In a step 301, the sensor 14 senses the surrounding volume of the digital photo frame 10.

Continuing to a decision step 302, the sensor 14 determines if the surrounding volume is larger than a preset threshold. For example, the preset threshold may be set to 30 db, because a normal human voice volume is about 40 db to about 50 db. If the surrounding volume is greater than the preset threshold, then the method continues to a step 303. If the surrounding volume is less than 30 db, then the method skips to a step 304.

In the step 303, the recorder 12 starts to record.

In the step 304, the recorder 12 does not record.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for making a digital photo album on a digital photo frame, the method comprising:
selecting a plurality of photos in the digital photo album, and ranking the selected photos;
reviewing each of the selected photos one at a time in the digital photo frame;
detecting if there is audio input when reviewing each of the selected photos;
recording the audio if audio input has been detected;
storing a plurality of information corresponding to the photo.

2. The method of claim 1, wherein the digital photo frame comprises a sensor configured to detect surrounding volume of the digital photo frame.

3. The method of claim 2, wherein audio input is detected if the surrounding volume is greater than a preset threshold.

4. The method of claim 3, wherein the preset threshold is 30 db.

5. The method of claim 1, wherein the audio is selected from the group consisting of an oral recording and background music.

6. The method of claim 1, wherein the plurality of information comprises a location path of the photo, a duration time of reviewing the photo, and the corresponding audio input.

7. A method for making a digital photo album on a digital photo frame comprising a control unit, a display connected to the control unit, a memory connected to the control unit, a recorder connected to the control unit, and a sensor connected to the recorder, the method comprising:
selecting a plurality of photos from the memory of the digital photo album, and ranking the selected photos;
reviewing each photo on the display;
detecting if there is audio input when reviewing each photo;
recording the audio if there is audio input, and storing the audio in the memory as an audio file; and
storing a plurality of information corresponding to each photo.

8. The method of claim 7, wherein the sensor senses surrounding volume of the digital photo frame to detect if there is audio input.

9. The method of claim 8, wherein if the surrounding volume is larger than a preset threshold, there is audio input.

10. The method of claim 9, wherein the preset threshold is 30 db.

11. The method of claim 7, wherein the audio is selected from the group consisting of an oral recording and background music.

12. The method of claim 7, wherein the plurality of information comprises a location path of the photo, a duration time of reviewing the photo, and the corresponding audio file.
